(19) United States
(12) Patent Application Publication
(10) Pub. No.: US 2002/0105175 A1
(43) Pub. Date: Aug. 8, 2002

(54) AN INFLATABLE SEAT BELT ANCHORAGE AND INFLATING SYSTEM

(76) Inventors: DONALD J. LEWIS, SCOTTSDALE, AZ (US); THOMAS J. GREEN, PHOENIX, AZ (US)

Correspondence Address: DAVID M RONYAK, THE BF GOODRICH COMPANY, PATENT LAW DEPARTMENT, 9921 BRECKSVILLE ROAD, BRECKSVILLE, OH, 441413289

(21) Appl. No.: 09/329,016

(22) Filed: Jun. 9, 1999

(51) Int. Cl. B60R 21/18

(52) U.S. Cl. 280/733

(57) ABSTRACT

A seat belt anchorage system for securing an inflatable seat belt in a vehicle has an inflator generating inflation-fluid and supplying the fluid through a fluid distribution member to a fluid receiving tube connected to the inflatable seat belt. The system shown being fully self-contained, that is not relying on external power, is adaptable to be secured to the vehicle during the initial manufacture of a vehicle or can be field retrofitted on existing vehicles. The seat belt anchorage system may be secured to the seat, seat back, seat frame, vehicle floor or vehicle structural member. The inflator is either coupled by a conduit or directly connected to the fluid distribution member. Of course if external power is available, the only portion of the anchorage system that will be changed is the configuration of the control of the inflator. Therefore, this system is transparent to the type and style of inflator devices.

### BACKGROUND OF THE INVENTION

1. Field of Invention

This invention relates to safety restraint systems in general and more particularly to systems for anchoring an inflatable seat belt assembly including the inflator, inflatable and seat belt to a passenger position in a vehicle be it a land, sea or air vehicle.

2. Description of the Related Art

Inflatables such as air bags in most vehicles rely on a single forward placed sensor for determining when and the severity of a crash of the vehicle. In most instances, the crash is a frontal crash causing the occupants due to inertia to continue in the direction of the vehicle movement. In automobiles, for instance, the sensor and the inflator for the inflatable are generally located forward of the occupant. Although in some instances, such as Inflataband™ restraint systems, available from Universal Propulsion Company, Phoenix, Arizona, the inflator may be located in various positions around the occupant including behind him in the seat back, above him in the roof rails and below him in the seat. In such instances, the sensor can be located in proximity of the inflator or in the front of the vehicle.

In large capacity vehicles such as buses and airplanes, wherein there are rows of seats for occupants, it is desirable to have self-contained, i.e. all in one, inflation systems at each occupant seat position. This is so because the crash event may cause sequential peak deceleration signals to occur at different seating positions due to the time that it takes the signal to transverse through the vehicle. The first or beginning signal occurs at the time that the vehicle receives its first sudden deceleration signal and continuing in sequence through the transverse length of the vehicle.

### SUMMARY OF INVENTION

It is a principle advantage of the present invention to provide a seat belt anchorage system containing an inflator, an inflatable and the various sensing systems necessary to protect the occupant in the event of a sudden deceleration of the vehicle.

It is yet another advantage of the present invention to have a seat belt anchorage system that is adapted to be retrofitted to existing seats.

It is still another advantage of the present invention to have a seat belt anchorage system that appears to the vehicle occupant to be nothing more than a seat belt system that is similar to all previous systems the occupant has used in vehicles such as automobiles, airplanes, etc.

It is yet still another advantage of the present invention to have a self-contained seat belt anchorage system to sense the crash deceleration signal at each occupant seating location as the crash signal or crash pulse travels the distance from the initial signal reception point to an aft seating position. The timing of such travel distance is in dozens of milliseconds after the initial reception of the crash pulse to the detection of the crash pulse at the aft occupant seating position.

These and other advantages will become apparent in a seat belt anchorage for securing an inflatable seat belt to a seat in a vehicle. The anchorage has a fluid distribution member. The fluid distribution member is operatively connected to a source of inflatable fluid for distributing the inflation fluid. A chamber member is coupled to the fluid distribution member to receive the inflation fluid from the fluid distribution member. The chamber member is secured to the seat by a mounting member rotatively mounted in a position proximate the intersection of and outboard of the seat back member and the seat member of the seat. Attached to the fluid distribution member is an Inflator to provide an inflation fluid or gas that exits the inflator through its outlet to the fluid distribution member. These and other advantages of the present invention will become apparent from the following detailed description including the following drawings.

### DESCRIPTION OF THE DRAWINGS

In the drawings:

FIG. 1 is side view of the seat belt anchorage system mounted on a seat frame;

FIG. 2 is a perspective view of a fluid distribution member;

FIG. 3 is a top view of an air chamber;

FIG. 4 is a sectional view taken along line 4-4 in FIG. 3;

FIG. 5 is a sectional view taken along line 5-5 in FIG. 3;

FIG. 6 is a perspective view of the bracket supporting the air chamber;

FIG. 7 is an enlarged sectional view of the air chamber with the inflatable seat belt system attached thereto;

FIG. 8 is a schematic view of the inflator control system; and

FIG. 9 is a front view, partially in section of a portion of the seat and the inflatable system.

### DETAILED DESCRIPTION OF THE PREFERRED EMBODIMENT

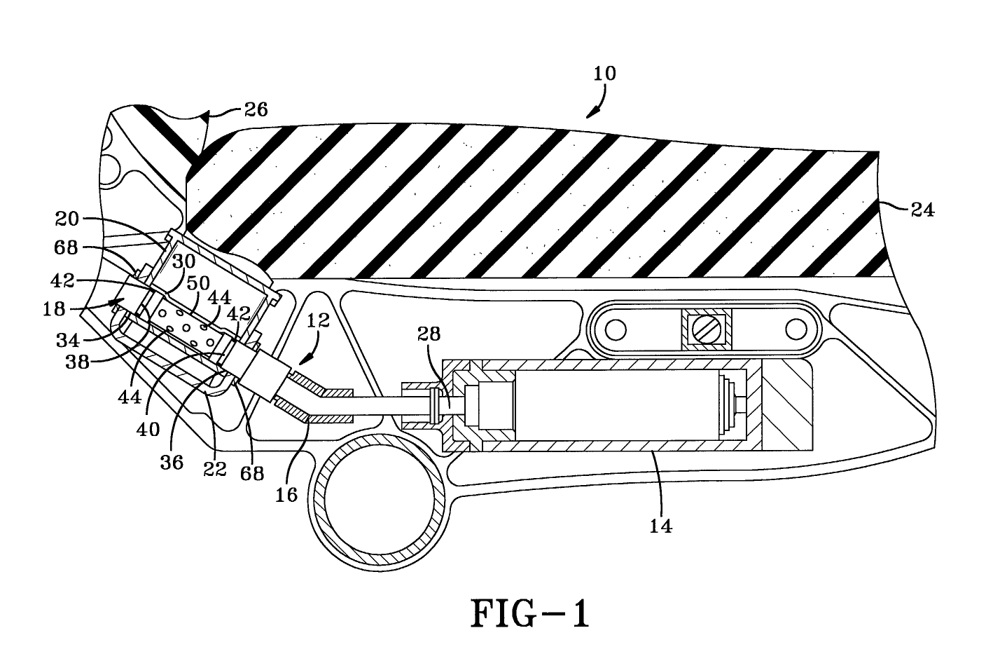

Referring to the Figs by the characters of reference there is illustrated in FIG. 1 a fragmentary side view of a vehicle seat 10 such as is found in aircraft vehicles. To this seat 10 there is added a seat belt anchorage system 12 that is adapted to be fitted to an existing vehicle seat 10. The anchorage system has an inflator 14, a conduit member 16 including the necessary fittings connected to the inflator, a fluid destribution member 18, a chamber member or an air chamber 20 and a mounting member 22 to secure the air chamber 20 to the vehicle seat 10. The inflator 14 may be that as shown and described in co-pending patent application assigned to a common assignee and entitled High Thermal Efficiency Inflator and Passive Restraints Incorporating Same which is a continuation-in-part of co-pending U.S. application Ser. No. 08/587,773, filed Dec. 22, 1995 and having Docket Number 9424-50.

The inflator 14 is securely mounted to the vehicle seat 10 at location that is below or beside the cushion 24 or seat bottom portion of the seat and proximate the intersection of the seat back 26 and the seat cushion 24. As an alternative embodiment, the inflator 14 can be securely mounted to any structural member of the vehicle such as a pillar or the floor. Typically the inflator 14 is mounted on the vehicle seat 10 and below and to the rear of the seat cushion 24 so as to be out of the way of the occupant and also, out of the way of the occupant in the row behind. Another position of the inflator 14 is its attachment to the separator member, not shown, between adjacent seats in a seating row such as found in the passenger cabin of an airplane.

The output 28 of the inflator 14, through which inflation fluid or gas passes, is connected by a conduit member 16 to the fluid distribution member 18. The conduit is typically a metal tube although other tubing materials such as reinforced rubber or plastic may be used. The function of the conduit member 16 is to conduct the inflation fluid from the inflator 14 to the fluid distribution member 18 wherever it is located.

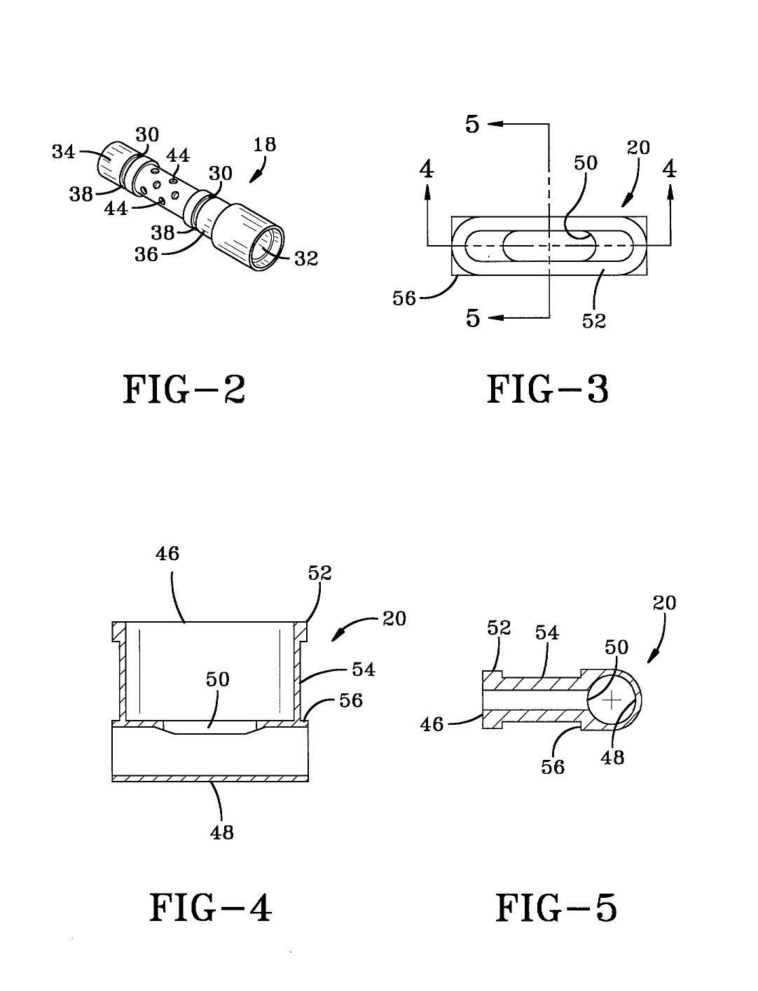

Referring to FIG. 2, there is illustrated the fluid distribution member 18 of the preferred embodiment. The member 18 is a stepped diameter tubular member 30 having an inlet 32 at one end connected to the conduit member 16. The opposite end of the member 18 is closed. At each end of the tubular member 30 there are bearing surfaces 34, 36 and circumferentially extending slots 38, 40 to locate and hold O-rings 42. As will hereinafter be shown, the O-rings 42 function to seal the fluid distribution member 18 and the chamber 20. Located around the perimeter of the intermediate section of the member is a plurality of radially extending orifices 44. These orifices 44 extend in a direction that is orthogonal to the axis of the tubular member and function to direct the flow of the inflation fluid from inside the member 30 to the outside.

The inflation fluid leaves the output 28 of the inflator 14 at a relatively high pressure and flows through the conduit member 16 and into the fluid distribution member 18. Since the member 18 is closed at the end opposite the inlet 32, the inflation fluid is directed out of the radially extending orifices 44. The cross-sectional area of the various parts of the system described, i.e. the output 28 of the inflator 14, the conduit member 16 and the fluid distribution member 18 increases in the direction of fluid flow. The number and the size of the orifices 44 determines the cross-sectional area to the passage of the inflation fluid from the fluid distribution member 18. In the present embodiment, the fluid distribution member 18 has sufficient cross-sectional area in the orifices along with the orientation of the orifices 44 to cause the fluid distribution member 18 to be thrust-neutralized to the flow and force of the inflation-fluid. The orifices 44 allow the inflation fluid to change its flow direction approximately ninety degrees and into a much larger flow area of the air chamber 20.

Referring to FIGS. 3-5, here is Illustrated the air chamber 20 of the preferred embodiment. As will be shown, the air chamber 20 and the fluid distribution member 18 rotate relative to each other or are integrally connected to rotate as a unit. In the preferred embodiment, the air chamber 20 being connected to the seat belt assembly 55 must rotate as the seat occupant moves the seat belt webbing 70. In an alternate embodiment, both the air chamber and the fluid distribution member are integral or of an unitary construction so that the complete device comprising the fluid distribution member 18 and the air chamber 20 rotate relative to the mounting bracket 22.

As illustrated in FIG. 4, the air chamber 20 has an elongated tubular member 48 that has an inside diameter equal to the diameter of the bearing surfaces 34, 36 of he fluid distribution member 18. This permits the two, the fluid distribution member 18 and the air chamber 20, to be free to relatively rotate while maintaining the seal formed by the O-rings 42. Intermediate the ends of the elongated member there is a slot 50 which opens the inside of the tubular member 48 to an elongated output section or nozzle 46 of the air chamber 20.

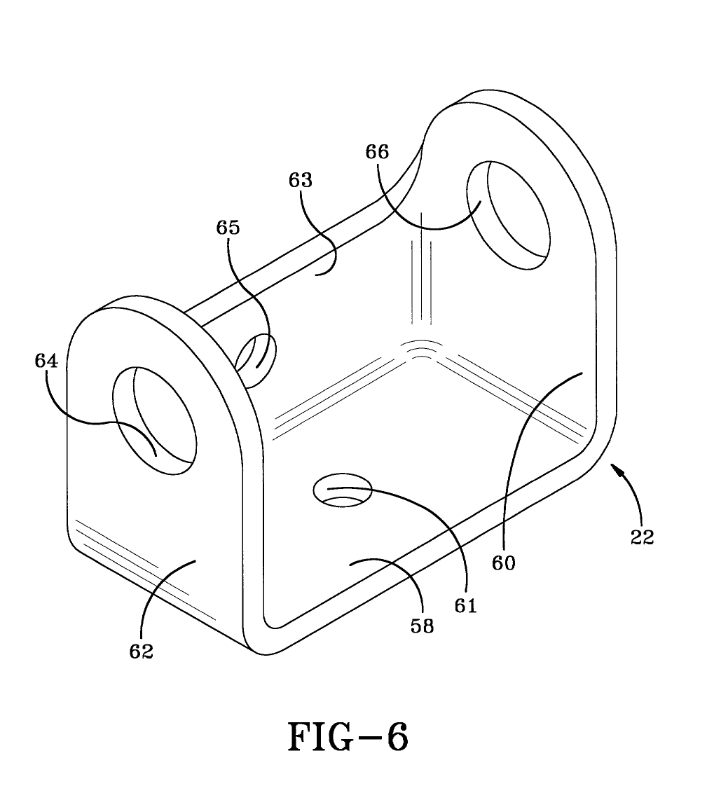

FIG. 5 is a cross-sectional view of the air chamber 20 showing the nozzle shape of the output section. The nozzle 46 is basically a rectangular cross-section having an extended height extending away from the tubular member portion 48. At the outlet end of the nozzle 46 there is a ridge or a rim 52 that extends around the outside surface of the nozzle 46. The ridge or rim 52 defines the outer limits of a flat surface 54 between the rim 52 and a similar ridge 56 of substantially equal height at the tubular member 48. This flat surface 54, as will hereinafter be shown, supports the seat belt assembly 55.

Again the cross-sectional area of the inside of the nozzle 46 is greater than the cross section area of the slot 50 and the total of the areas of the orifices 44 of the fluid distribution member 18. As the inflation fluid leaves the output 28 of the inflator 14, each new section has a cross-sectional area that is larger than the previous cross-sectional area, each new cross-sectional area is less than twice the preceding cross-sectional area. This reduction in the cross-sectional area reduces the pressure of the inflation fluid at each step and minimizes the formation of deleterious shock waves.

The mounting member 22 is illustrated in FIG. 6 and is a generally U-shaped member having a base 58, a pair of outwardly extending arms 60, 62 and a back member 63. The mounting member or bracket 22 is rotatively mounted to the vehicle seat 10 or seat frame at its base 58 via mounting hole 61 or back member 63 via mounting hole 65 and functions to locate the seat belt assembly 55. Prior to a crash, when the seat belt assembly 55 experiences a crash event, the mounting member 22 rotates relative to the vehicle seat 10, seat frame, or vehicle structural member. This rotation facilitates a more even transfer of the load from the air chamber 20 to the seat belt assembly 55. In the alternate embodiment, the air chamber 20 and the fluid distribution member 18 being integral, axially rotate about an axis extending through the bearing holes 64, 66 in the outwardly extending arms 60, 62 of the mounting member 22.

The fluid distribution member 18 is inserted in one of the bearing holes 64 or 66 in the arms 60, 62. The air chamber member 20 is then slid over the fluid distribution member 18 including its O-rings 42. The end of the fluid distribution member 18 is then inserted in the other bearing hole 66 or 64 in the other arm 62 or 60 and secured there by a c-clip 68 or other similar holding device.

In the alternative, the fluid distribution member 18 maybe a multiple piece member, such as a two piece member. Each piece is terminated in a threaded portion. The air chamber member 20 is then inserted between the two arms 60, 62 with the tubular member 48 in line with the two bearing holes 64, 66 of the bracket 22. Then each piece of the fluid distribution member 18 is inserted respectively through the two bearing holes in the arms of the bracket and then threaded together in a leak tight manner. C-clips 68 are used to secure the threaded assembly of the fluid distribution member 18 and the air chamber 20 in the bracket 22.

Prior to putting the air chamber 20 together with the fluid distribution member 18, a seat belt assembly 55 is secured to the flanged nozzle 46 of the air chamber 20. Referring to FIG. 7. there is illustrated how the seat belt assembly 55 for an inflatable seat belt is securely connected to the air chamber flanged nozzle 46. The seat belt assembly 55 is described and claimed in co-pending patent application having a BFG docket number 1990027 and entitled Inflatable Air Bag For An Inflatable Restraint System and assigned to a common assignee and is incorporated herein by reference.

As illustrated, the inflatable seat belt assembly 55 in the preferred embodiment has an elongated seat belt webbing 70 that is mounted to the air chamber nozzle 46 at one end of the seat belt webbing 70. The other end of the seat belt webbing 70 extends to the other side of the seat wherein it typically has a tongue and buckle arrangement 72 with the buckle generally fixedly secured by some flexible means to the vehicle seat 10. The seat belt webbing 70 has an inflatable member 74 mounted thereto intermediate its ends between the air chamber 20 and the tongue member 72. As this portion of the assembly is not the subject of the invention, it is not shown here. In essence, the operation of the Inflatabelt™ system as far as an occupant hooking up is the same as in all previous uses of a seat belt.

Since the subject of this application is an inflatable seat belt anchorage system 12, the inflatable member 74 must be connected to receive inflation-fluid from the inflator 14. The air chamber nozzle 46 directs the inflation fluid through an inflatable-fluid receiving tube or snout 76 that is mounted on one surface of the seat belt webbing 70 and connected to the inflatable member 74.

In FIG. 7, illustrates one way of connecting the inflatable seat belt assembly 55 to the air chamber 20. The snout 76 is pulled over the outer rim 52 of the nozzle 46 and lies along the flat surface 54 between the outer rim 52 and an inner ridge or rim 56. The fit between the snout 76 and the nozzle 46 is one that is substantially leak-tight. As described in the co-pending patent application, the seat belt webbing 70 has mounted to it the snout 76 and the inflatable member 74. Thus, the webbing 70 is placed over the snout 76 and in order to secure the webbing 70 and to hold it against the high loads that it will be applied. The webbing 70 is then wrapped around the end of the air chamber 20. The webbing 70 is then brought back to the outer rim 52 on the other side of the nozzle 46 where by means of a pin member 80 it is fed to the back of the air chamber 20. The webbing 70 is typically bonded 81 to the air chamber 20. However, it may not be bonded to the air chamber 20 if the designer feels that the clamping assembly 82 is strong or tight enough to hold the high seat belt loads that will develop when the inflatable member 74 is inflated.

In the preferred embodiment, a frangible tubular cover 78 encloses the inflatable member 74, the snout 76 and the seat belt webbing 70. This frangible tubular cover 78 is shown and claimed in co-pending U.S. patent application having Ser. No. 09/099,858 filed on Jun. 18, 1998 by Hammer et al. and entitled Belt System with Inflatable Section Within an Outer Belt Section and Method of Restraint. This co-pending application is incorporated herein by reference.

The frangible tubular cover 78 then pulled over the webbing 70 on the nozzle 46 up to the inner ridge or rim 56. The clamping assembly 82 is placed around the frangible tubular cover 78, the webbing 70 and the snout 76 to secure them to the nozzle 46.

The clamping assembly 82, as illustrated in FIG. 7 comprises a metal band 84 that overlies a flat surface member 86 in order that the band 84 does not damage the frangible tubular cover 78. The band 84 is tightened to keep the seat belt assembly 55 on the air chamber nozzle 46 when the inflation fluid flows to the inflatable member 74. Forces in the range of 700 pounds or 318 Kilograms are experienced when the inflatable is inflated to restrain the occupant.

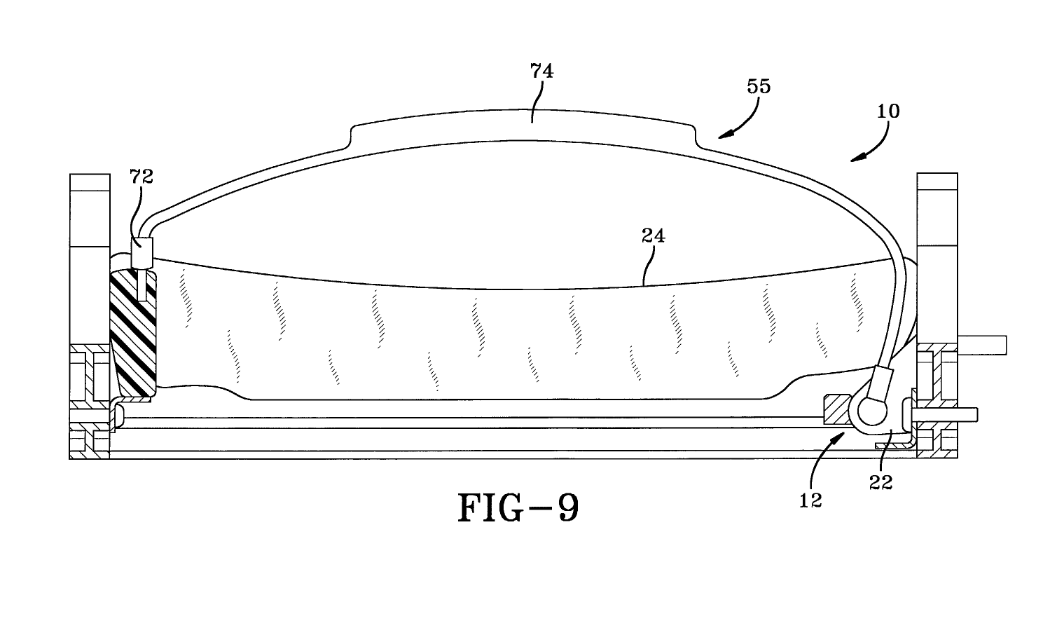

This fully assembled air chamber 20 with the seat belt assembly 55 is then slipped on the fluid distribution member 18, in a manner as previously described, and secured between the upright arms 60, 62 of the mounting bracket 22. The mounting bracket 22 is secured to the vehicle seat 10 or a vehicle structure as previously mentioned. The air chamber 20 and fluid distribution member 18 are able to rotate as an integral or unitary member about an axis through the bearing holes 64, 66 of the mounting bracket 22. The rotation follows the movement of the seat belt assembly 55 as an occupant secures the inflatable seat belt assembly about his or her waist. This is illustrated in FIG. 9 wherein the seat belt assembly is illustrated as extending from one side of the vehicle seat 10 to the other side of the vehicle seat. In FIG. 9, the occupant is not shown for purposes of clarity and the seat belt assembly 55 is rotated for better illustration.

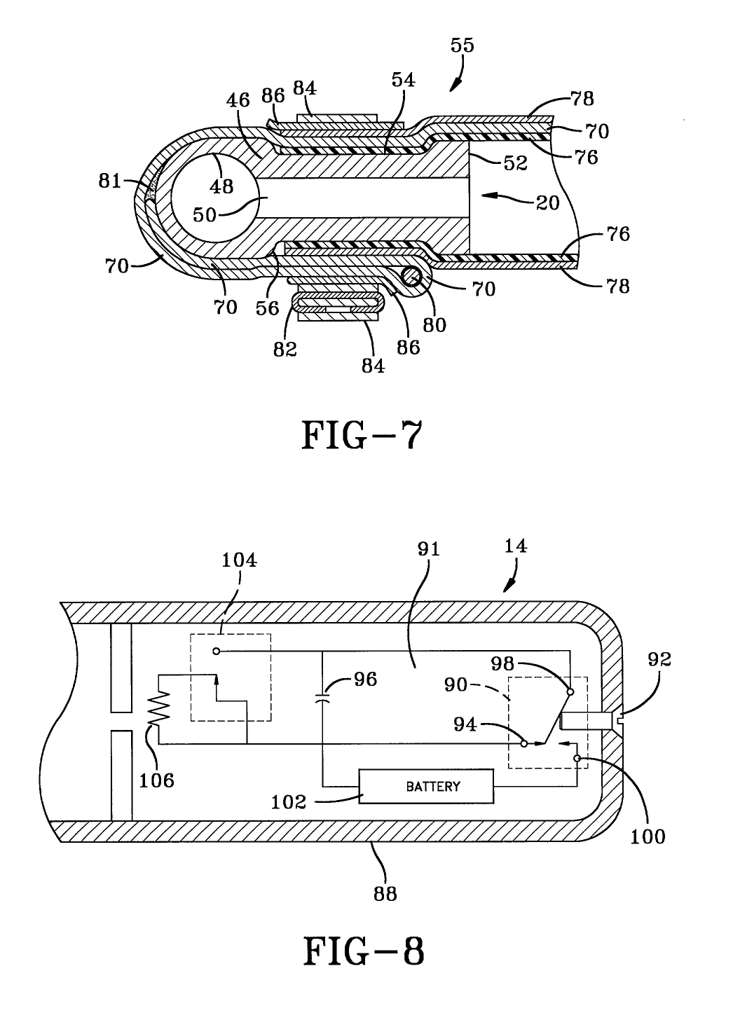

In the preferred embodiment, the control circuit 91 of the inflator 14 is similar to that schematically illustrated in FIG. 8. Inside the faraday shield housing 88 of the inflator, beginning at the end opposite the outlet 28 of the inflator 14, there is a safety or arming switch 90. The switch is ready for arming when the seat belt anchorage system 12 is bolted to the vehicle seat 10 and ready for operation. To arm the switch 90, the setscrew 92 is removed. This switch 90 is represented as a single pole double throw switch wherein the normally open contact 94 is connected to one side of the firing capacitor 96 and the single pole 98 is connected to the other side of the capacitor 96. In this manner, with the setscrew 92 in place, the firing capacitor 96 is shorted out and will not be charged.

The normally closed contact 100, which is held open by the setscrew 92, is connected to the battery 102. The battery 102 has a shelf-life of many years. This long life predisposes that there is not an external power source and the inflator 14 must be in place for a long time to supply the necessary power to the several circuit elements when a sudden deceleration of the vehicle or a crash occurs.

These elements include a crash or acceleration sensor or switch 104 that will detect a sudden deceleration of the vehicle indicating the need for or conditions indicating the need for the deployment of the inflatable to protect the occupant. The sensor 104 is initially adjusted for working in the various force environments such as found in automobiles, airplanes, etc. The output of the control circuit of the inflator 14 is a squib 106 for igniting the propellant within the inflator. The control circuit 91 is enclosed in a faraday shield 88 in the inflator 14 for preventing external signals from activating the inflator elements.

The details of the inflator 14 are not subject of this application other than how it is assembled in the system 12. The inflation fluid has passed through a burst disk in the inflator 14 and through the conduit member 16. The inflatable fluid distribution member 18 receives the fluid from the conduit member and directs the fluid to the air chamber 20. From the air chamber 20 the inflation-fluid is delivered through the snout 76 to the inflatable member 74.

There has thus been shown and described an inflatable seat belt anchorage system for securing an inflatable seat belt to a seat in a vehicle. The vehicle can be an automobile, a bus, an airplane or any vehicle that carries occupants and that may be subject to sudden decelerations caused by a crash or similar action. It is to be appreciated that the seat belt anchorage system 12 can be used with inflatable seat belts of configurations other than those shown and described herein and with other crash or acceleration sensors and inflator systems.

What is claimed is:

1. A seat belt anchorage for securing an inflatable seat belt to a seat in a vehicle, the anchorage comprising:
a fluid distribution member operatively connected to a source of inflation fluid for inflating inflatable seat belts;
a chamber member coupled to said distribution member and operable to receive the inflation fluid from said distribution member; and
a mounting member for securing said chamber member to the seat.

2. A seat belt anchorage according to claim 1 wherein said mounting member is mounted in a position proximate the intersection of and outboard of the seat back member and the seat member of the seat.

3. A seat belt anchorage according to claim 1 wherein said mounting member is mounted in a position proximate the intersection of and outboard of the seat back member and the seat bottom member portion of the seat.

4. A seat belt anchorage according to claim 1 wherein said source of inflation fluid is an inflator for providing the fluid that exits through the output of said inflator to said fluid distribution member.

5. A seat belt anchorage according to claim 4 wherein said inflator includes a sensor for sensing sudden deceleration vehicle signals, a battery, a firing capacitor, a squib and a gas generator.

6. A seat belt anchorage according to claim 5 wherein said inflator is enclosed in a faraday shield.

7. A seat belt anchorage according to claim 5 additionally including an arming switch for rendering said inflator operable.

8. A seat belt anchorage according to claim 4 wherein said inflator is a chemical gas generator inflator providing an inflation fluid that exits through the output of said inflator to said fluid distribution member.

9. A seat belt anchorage according to claim 4 wherein said output of said inflator is directly coupled to said fluid distribution member.

10. A seat belt anchorage according to claim 4 wherein said inflator is mounted to the seat and below the seat member.

11. A seat belt anchorage according to claim 4 wherein said inflator is mounted to a structural member of the vehicle.

12. A seat belt anchorage according to claim 4 wherein said inflator is mounted to the seat frame.

13. A seat belt anchorage according to claim 4 wherein said inflator is mounted to a seat separator frame between adjacent seating positions.

14. A seat belt anchorage according to claim 11 wherein said inflator is mounted on a structural member of the vehicle and is connected to said fluid distribution member by a conduit member.

15. A seat belt anchorage according to claim 11 wherein said structural member of the vehicle is the floor of the vehicle.

16. A seat belt anchorage according to claim 1 wherein said fluid distribution member is a tubular member having a plurality of radially extending orifices intermediate the ends of the tubular member.

17. A seat belt anchorage according to claim 16 wherein said fluid distribution member receives the inflation fluid axially and said orifices extend in a direction orthogonal to said axis with the total area of said extending orifices functioning to make said distribution member thrust neutralized.

18. A seat belt anchorage according to claim 16 wherein said distribution member is an enclosed tubular member.

19. A seat belt anchorage according to claim 1 wherein said distribution member is a multiple piece tubular member threadably connected together in a leak-tight connection and having a plurality of radially extending orifices intermediate the ends of the tubular member.

20. A seat belt anchorage according to claim 19 wherein said multiple piece distribution member is a two-piece tubular member having each tubular piece threadably connected together in a leak-tight connection and having a plurality of radially extending orifices intermediate the ends of the tubular member.

21. A seat belt anchorage according to claim 1 wherein said chamber member is rotatably mounted to said distribution member.

22. A seat belt anchorage according to claim 1 wherein said chamber member and said distribution member are integrally connected together and rotatably mounted to said mounting member.

23. A seat belt anchorage according to claim 1 wherein said chamber member and said distribution member are sealed by O-rings.

24. A seat belt anchorage according to claim 1 additionally including:
an inflatable seat belt having an elongated seat belt webbing mounted to said chamber member at one end of said seat belt webbing with the other end of said seat belt webbing extending to the other side of said seat; and
an inflatable member mounted to said seat belt webbing intermediate the ends of said seat belt webbing.

25. A seat belt anchorage according to claim 11 additionally including:
an fluid receiving tube for receiving inflation fluid, said tube being mounted on said seat belt webbing and connected to said inflatable member; and
a frangible tubular cover enclosing said inflatable member, said fluid receiving tube and said seat belt webbing, said fluid receiving tube being in fluid communication with said chamber member.

26. A seat belt anchorage according to claim 4 wherein the cross-sectional area of the fluid passageways from said inflator to said chamber member increases in the direction of the inflation fluid flow.

27. A seat belt anchorage according to claim 26 wherein the cross-sectional area of the fluid passageways from said inflator to said distribution member is greater than the cross-sectional area of said outlet of said inflator.

28. A seat belt anchorage according to claim 1 wherein said chamber member has an outlet cross-sectional area greater than its inlet cross-sectional area and the cross-sectional area of the inlet to said chamber member is greater than the cross-sectional area of said inlet of said distribution member.

29. A seat belt anchorage according to claim 1 wherein said mounting member is mounted for rotation.

30. A seat belt anchorage according to claim 26 wherein each cross-sectional area change in said fluid passageways is less than twice the cross-sectional area of the immediately previous cross-sectional area.
